(19) United States
(12) Patent Application Publication
(10) Pub. No.: US 2006/0156243 A1
(43) Pub. Date: Jul. 13, 2006

(54) Systems and methods for sharing loops

(75) Inventors: Prescott V. Lee, Menlo Park, CA (US); Kyle S. Mashima, Menlo Park, CA (US)

Correspondence Address: CARR & FERRELL LLP, 2200 GENG ROAD, PALO ALTO, CA, 94303, US

(73) Assignee: FilmLoop, Inc.

(21) Appl. No.: 11/174,305

(22) Filed: Jul. 1, 2005

Related U.S. Application Data
(60) Provisional application No. 60/644,254, filed on Jan. 13, 2005.
(60) Provisional application No. 60/644,129, filed on Jan. 13, 2005.

(51) Int. Cl. G06F 17/00; G06F 3/00; G06F 9/00; H04N 11/00; G06F 17/21

(52) U.S. Cl. 715/741; 386/1; 715/743; 715/751; 715/500.1

(57) ABSTRACT

An exemplary system and method for creating and sharing media is provided. In exemplary embodiments, a loop having items of media is created by a user. Permissions for accessing and modifying the loop including the items of media in the loop are set by the user. Subsequent users may access and modify the loop subject to the permissions.

### CROSS-REFERENCE TO RELATED APPLICATIONS

The present application claims the benefit and priority of U.S. provisional patent application Ser. No. 60/644,254 filed on Jan. 13, 2005 and entitled “Systems and Methods for One Click Photo Sharing,” and U.S. provisional patent application Ser. No. 60/644,129, filed on Jan. 13, 2005 and entitled “Systems and Methods for Drag and Drop Loops,” which are herein incorporated by reference.

This application is related to co-pending U.S. application Ser. No. ______, entitled “Systems and Methods for Providing Loops,” filed on Jul. 1, 2005, co-pending U.S. Application Ser. No. ______, entitled “Systems and Methods for Single Act Media Sharing,” filed on Jul. 1, 2005, co-pending U.S. application Ser. No. ______, entitled “Systems and Methods for Providing an Interface for Interacting with a Loop,” filed on Jul. 1, 2005, co-pending U.S. application Ser. No. ______, entitled “Systems and Methods for Single Input Installation of an Application,” filed on Jul. 1, 2005, and co-pending U.S. application Ser. No. ______, entitled “Loop Channels,” filed on Jul. 1, 2005, which are herein incorporated by reference.

### BACKGROUND OF THE INVENTION

1. Field of the Invention

The present invention relates generally to sharing loops, and more particularly to systems and methods for sharing loops with access and modification permissions.

2. Description of Related Art

Presently, people are accustomed to exchanging data in a plurality of methods. Users of computing devices share information via personal digital assistants (PDAs), mobile phones, and computers, for example. Information in the form of media is frequently shared among users so that they can present visual and/or audio media to other users. For example, a user can take a snapshot of a subject via a mobile phone, and send that snapshot to a friend's laptop.

Conventionally, media is communicated from one user to another user through a long series of steps. For instance, the user may access a file containing the media in a directory on the user's computing device to locate the media the user wishes to share. Upon locating the media, the user may select the file or right click on the file, and select an option, such as “send file by electronic mail.” When the “send file by electronic mail” option is selected, an electronic mail window opens in which the user can enter text and send the file containing the media to a second user. Alternatively, the user may open an electronic mail window and attach the file, and send an electronic mail message along with the attachment to the second user. The process of communicating media from one computing device to another can take several minutes, because of the number of steps involved in locating, addressing, and sending the media to specified users.

Typically, the first user cannot control how the second user will use the received media. For example, the second user may modify the media and/or send the media to more users. Often times, modifications and further dissemination of the media occur without the knowledge of the first user.

Therefore, there is a need for a system and method for efficiently sharing media. There is a further need to be able to restrict editing and access of the shared media.

### SUMMARY OF THE INVENTION

An exemplary system and method for creating and sharing media is provided. In exemplary embodiments, a loop containing items of media is created by a user. The items of media may comprise any audio or visual data such as, for example, photos, videos, movies, songs, graphics, or advertisement. When creating the loop, the user can provide various permissions for accessing and modifying the loop or the items of media in the loop. The user can also provide permissions for further sharing rights (i.e., if a particular user is allowed to further share the loop).

In one embodiment, the user may allow the loop to be listed in a public directory. By doing so, the user will allow the general public to access the loop. The user, however, may still deny modifications to the loop via the permissions.

In another embodiment, the user may send an invitation to a other user to access the shared loop. The invitation may comprise the loop, itself, or it may comprise a ticket identifier of the shared loop. The other user may then use the ticket identifier to access the loop (e.g., download the loop from a server).

When the user attempts to access the loop or modify the items of media on the loop, a media engine or the server reviews the permissions for the loop to determine if the access and modifications are allowed for the particular user.

### BRIEF DESCRIPTION OF THE DRAWINGS

FIG. 1 is an exemplary screenshot of a loop on a loop player, in accordance with one embodiment;

FIG. 2 is a block diagram of an exemplary environment for practicing the present invention;

FIG. 3 is an exemplary block diagram of a media engine;

FIG. 4 is an exemplary block diagram of components associated with a server;

FIG. 5 is a screenshot of a new loop window in accordance with one embodiment;

FIG. 6 is a screenshot of a share loop window in accordance with one embodiment;

FIG. 7 is an exemplary flowchart of a method for creating and sharing a loop;

FIG. 8 is an exemplary flowchart of a method for accessing and editing a loop; and

FIG. 9 is an exemplary flowchart for determining if a user has permissions to perform certain modifications to the loop.

### DESCRIPTION OF EXEMPLARY EMBODIMENTS

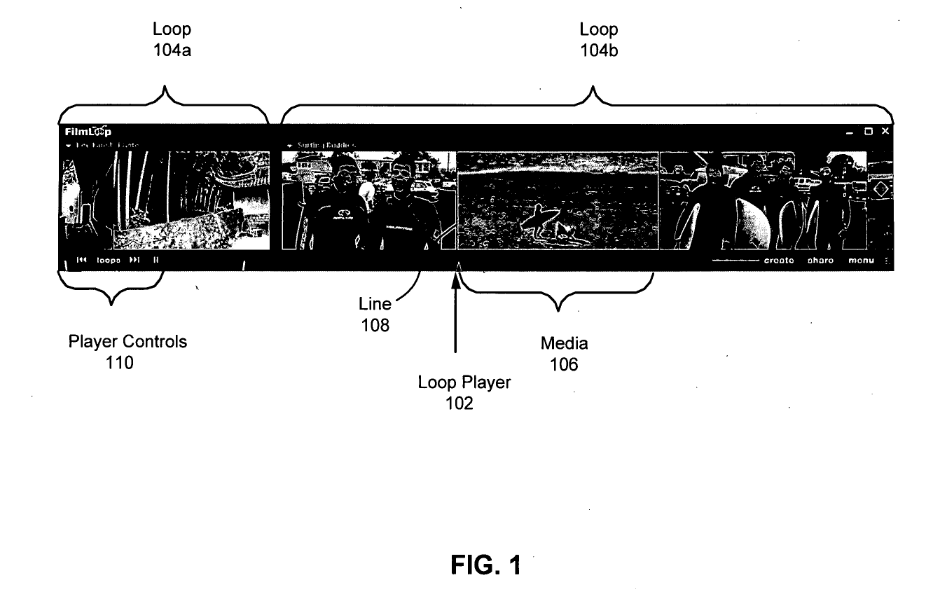

FIG. 1 is a screenshot of an exemplary loop player 102 operating on a computing device. The computing device may be, for example, a personal digital assistants (PDAs), mobile phones, or personal computer. The loop player 102 displays loops 104. Any number of loops 104 may be displayed by the loop player 102. In exemplary embodiments, the loops 104 scroll across the loop player 102.

Each loop 104 comprises various items of media 106. The media 106 may comprise photos, video, audio, images, text, advertisement, and any other type of data. The media 106 may appear as one or more items separated by a line, frame, or any other separation device 108 for defining the one or more items of media 106. The media 106 may, itself, include moving displays, videos, or further media. The media 106 can be manipulated by the user, as will be described in more detail hereafter.

As shown in the present embodiment, portions of two loops 104 are being displayed at the same time. A first loop 104a is entitled “Lee Family Photos,” while a second loop 104b is entitled “Surfing Buddies.” Within the second loop 104b, a plurality of media 106 related to surfing is provided. For example, one item of media 106 of the second loop 104b is a photo of four surfers.

Player controls 110 are provided on the loop player 102 for manipulating movement and/or scrolling of one or more loops 104. The loops 104 may be manipulated by a user of the loop player 102 to stop, speed up, slow down, or change the direction of the scrolling. The player controls 110 are exemplary, and any type of mechanism may be provided for manipulating the loop(s) 104. Furthermore, any type of manipulation of loops 104 is within the scope of embodiments of the present invention.

The process of providing loops is described in further detail in co-pending U.S. application Ser. No. ______, entitled “Systems and Methods for Providing Loops,” filed on Jul. 1, 2005, which is incorporated by reference. The process of providing an interface for interacting with a loop is described in further detail in co-pending U.S. application Ser. No. ______, entitled “Systems and Methods for Providing an Interface for Interacting with a Loop,” filed on Jul. 1, 2005, which is incorporated by reference.

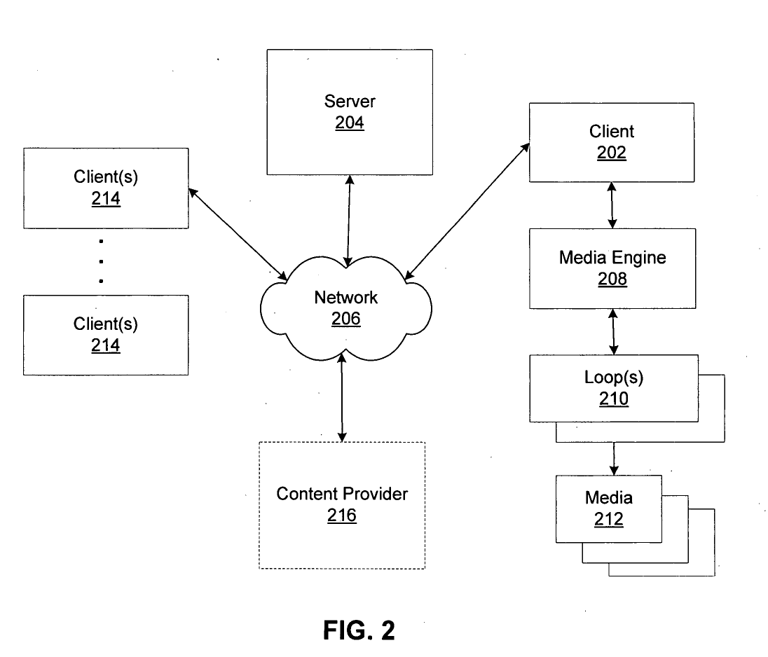

Referring now to FIG. 2, an exemplary environment 200 for practicing embodiments of the present invention is shown. According to exemplary embodiments, the environment 200 comprises a client 202 coupled to a server 204 via a network 206. The client 202 may be any computing device (e.g., laptop, mobile phone, PDA, etc.) associated with a user.

The client 202 is coupled to a media engine 208 which generates and/or manipulates at least one loop 210. Additionally, the media engine 208 provides the loop player 102 (FIG. 1) for displaying the at least one loop 210 on a display device of the client 202. In an alternative embodiment, the media engine 208 resides on the client 202. In yet a further embodiment, the media engine 208 is coupled to the client 202 via the network 206.

The media engine 208 is utilized to create loops 210 using media 212. Initially, a user at the client 202 creates an empty loop 210, and selects one or more items of media 212 from files located on, or coupled to, the client 202 to incorporate into the blank loop 210. For example, the client 202 may search for photos found on the Internet and provided these photos to the media engine 208, which then uses the photos to populate the loop 210. In one embodiment, the items of media 212 are provided to the loop 210 by dragging and dropping the items of media 212 into the loop 210. Alternatively, the user may initiate a command that the items of media 212 be used to populate the loop 210. In further embodiments, the user can drag a folder having a plurality of media 212 items into the loop 210.

In a manner similar to creating loops 210, a user may modify existing loops 210. Thus, the user may drag items of media 212 into or out of the existing loop 210 or drag a folder of media 212 items into or out of the existing loop 210. Alternatively, the user may initiate a command to add or remove items of media 212 from the existing loop 210. Any manner of identifying items of media 212 to add to, or remove from, the loop 210 is with in the scope of various embodiments. For example, the user may highlight the item of media 212 within the loop 210 and select a remove option from a drop down menu.

The exemplary media engine 208 assigns a loop identifier to each loop 210 it generates. The media engine may also assign a loop identifier and a media identifier to each of the media 212 in the loop 210. Thus, for example, the media engine 208 assigns a loop identifier to a generated loop 210 and assigns the loop identifier as well as media identifiers to each of the items of media 212 used to generate the loop 210. In exemplary embodiments, the media identifiers are unique within the loop(s) 210. Furthermore, the loop identifiers and/or the media identifiers may be unique within the network 206. In a further embodiment, the loop and media identifiers may be assigned by the server 204. The server 204 communicates identifiers to the media engine 208, so the media engine 208 can store and locate the identifiers.

When a user drags and drops items of media 212 into a loop 210, the user is requesting the media engine 208 modify the loop 210 by adding the dropped items of media 212. Accordingly, the media engine 208 may assign an identifier that is unique within the loop 210 to each of the items of the media 212 dropped by the user. Because an item of media 212 may be used in more than one loop 210, the items of media 212 may have more than one identifier (e.g., one for each loop 210 in order to identify which loop 210 contains the item of media 212). The process of dragging and dropping media 212 within the loop 210 is described in further detail in co-pending U.S. application Ser. No. ______, entitled “Systems and Methods for Single Act Media Sharing,” filed on Jul. 1, 2005.

The media engine 208 also updates loops 210 to reflect removal of items of media 212. The media engine 208 may remove the corresponding identifiers of the removed items of media 212. Alternatively, the media engine 208 may alter the metadata of the removed items of media 212 to reflect the removal.

As previously discussed, the user may initiate a command which instructs the media engine 208 to create or modify loops 210. The process may involve the use of the identifiers. For example, the media engine 208 receives a media identifier from the user for a loop 210, compares the media identifier with identifiers stored by the media engine 208, and creates or modifies the loop 210 with the item(s) of media 212 identified by the identifier. Further, if the item of media 212 has an associated loop identifier that matches an identifier of an existing loop 210, the media engine 208 may add the item of media 212 to the existing loop 210. If the item of media 212 selected by the user does not have an identifier, the media engine 208 may use the item of media 212 to create one or more new loops 210 or add the media to an existing loop 210. Similarly, the user may select a loop 210 to be modified based on its loop identifier. Once identified, the user can then identify items of media 212 (e.g., drag and drop, identifiers, copy and paste) to modify (e.g., add or remove items of media 212) the loop 210 with. In alternative embodiments, the items of media 212 and/or the loops 210 may be identified by other criteria such as subject matter or title.

When changes are made to loops 210 (e.g., items of media 212 added, removed, or modified), the media engine 208 and the server 204 may store and/or track the changes as updates to the loop 210. For example, if the user resizes an image of an item of media 212, the media engine 208 and the server 204 can include the resized image as an update to the media 212 in the loop 210. Furthermore, the media engine 208 or the server 204 may assign a new identifier to the resized image in the item of media 212.

In exemplary embodiments, a user of the client 202 may share one or more loops 210 with further clients 214. The further clients 214 may also have, or be coupled to, media engines (same or similar to media engine 208) for playing the loops 210 (e.g., the shared loops from client 202), creating loops 210, modifying loops 210, or any other manipulation of loops 210 allowed. For example, a further client 214 may add media 212, remove media 212, modify metadata of the media 212, or modify metadata of the loop 210.

The process of sharing loops is described in further detail in co-pending U.S. application Ser. No. ______, entitled “Loop Channels,” filed on Jul. 1, 2005, which is incorporated by reference.

When a user from the client 202 makes a modification to the loop 210 having an identifier shared by the loop 210 at the client(s) 214, the client(s) 214 receives the same modifications to the loop 210. The server 204 can provide the modifications to the loop 210 on the client(s) 214 automatically at any time after the user at the client 202 makes the modification to the loop 210. Because the server 204 may automatically distribute modifications to the client(s) 214 with loops 210 having the same identifier, only a single act is required by the modifying user to share the modifications with users at the client(s) 214. According to one embodiment, the server 204 makes requests to the media engine 208 coupled to the client 202 at various times for changes made to the loop 210 by the client 202. In an alternative embodiment, the server 204 waits for a notification from the client 202 of the modification to the loop 210, and then provides the modification to the client(s) 214 that have loops 210 with the same identifier. As discussed herein, the updates may include any modification to the media 212, the loop 210 comprising the media 212, and/or metadata associated with either.

In exemplary embodiments, master copies of the loop 210 may be stored on the server 204. Further, the server 204 may comprise an index for locating the master copy of the loop 210. In one embodiment, the index may comprise a list of identifiers. The users at the clients 202 and 214 can modify the master copy on the server 204 by accessing the server 204 via the network 206. Alternatively, the master copy of the loop 210 may be stored at the server 204, while the clients 202 and 214 utilize an index to retrieve the particular loop 210 to their computing device for viewing and modification. Any storage medium may be utilized for storing the loop 210, copies of the loop 210, metadata, and/or indices.

In another embodiment, the server 204 may store versions of the loops 210. Thus, the server 204 may maintain different versions of the same loop 210. In a further embodiment, the client 202 or 214 may store different versions of the loop 210 created by the client 202 or 214 or of shared loops 210. Both the server 204 and the clients 202 and 214 may maintain an index for organizing and tracking the various versions of the loop 210. The identifiers assigned to the different versions may, in exemplary embodiments, be similar to reflect the version (e.g., identifier#.1 for the first version and identifier#.2 for the second version).

In another embodiment, the media engine 208 associated with the client 202 assigns a temporary identifier to the media 212 added (e.g., dragged and dropped) to the loop 210. The client 202 then forwards the media 212 with the temporary identifier to the server 204. The server 204 then assigns a permanent identifier to the media 212 before forwarding the media 212 with the permanent identifier back to the client 202 and/or the further clients 214 as a modification. The temporary and permanent identifier associated with the media 212 may also be associated with the identifier assigned to the corresponding loop 210. In a further embodiment, the client 202 may only forward the temporary identifier to the server 204. The server 204 then assigns a permanent identifier to the media 212 before forwarding the permanent identifier back to the client 202.

It will be appreciated by those skills in the art that the clients 202 and 214 may be a part of a peer to peer network where no external server 204 is necessary. In some embodiments, the client 202 on a peer to peer network assigns an identifier to the loop 210 as well as the media 212 contained within the loop 210. Further, the client 202 may share the loop 210 and the media 212 with the client(s) 214. In other embodiments, the client 202 functions as a server 204 on a peer to peer network. For example, the client 202 may function as a server 204 for all loop(s) 210 created on the client 202. In this example, the client 202 will assign permanent identifiers for the media 212 within the loop 210. Similarly, client 214 will operate as a server 204 for loop(s) 210 created on the client 214.

The further client(s) 214 may also create and modify loops 210. Loop creation and modification by the client(s) 214 are in the same manner as that of the client 202, as previously described. Thus, the clients 202 and 214 are capable of performing similar or identical functions with respect to the loops 210.

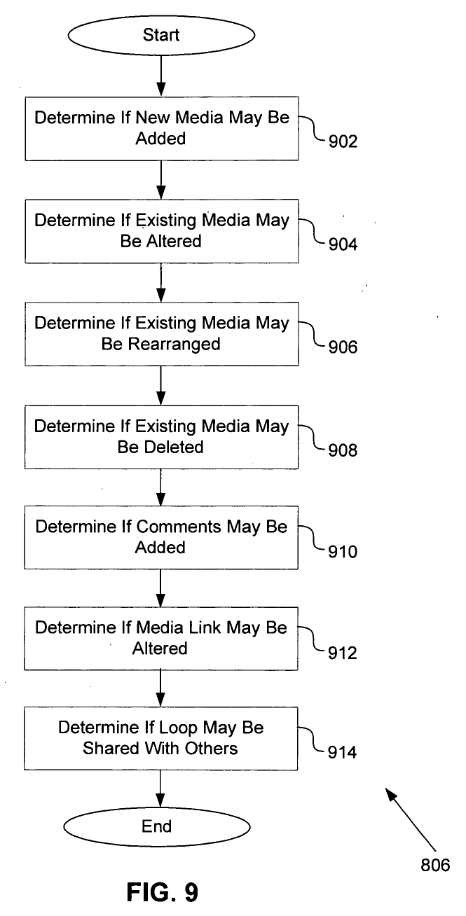

The user associated with the client 202 or 214 that creates a loop 210 can create permissions for the loop 210. The permissions determine which clients 202 or 214 can access the loop 210, make modifications to the accessed loops 210, or share the loops 210. Permissions will be discussed in more detail in connection with FIG. 9.

At least one optional content provider 216 may be coupled to the network 206. The content provider 216 provides various content to the loop 210; e.g. advertisements. In one embodiment, each loop 210 includes at least one item of content from the content provider 216. Accordingly, the loop 210 may display advertisements or other content along with the items of media 212 displayed by the loop 210. The content provider 216 can specify, according to one embodiment, how often its content appears within the loop 210. If the content provider 216 modifies the content, the server 204 or content provider 216 distributes the modified content as updates to the loops 210 (e.g., modified content replaces previous version of content).

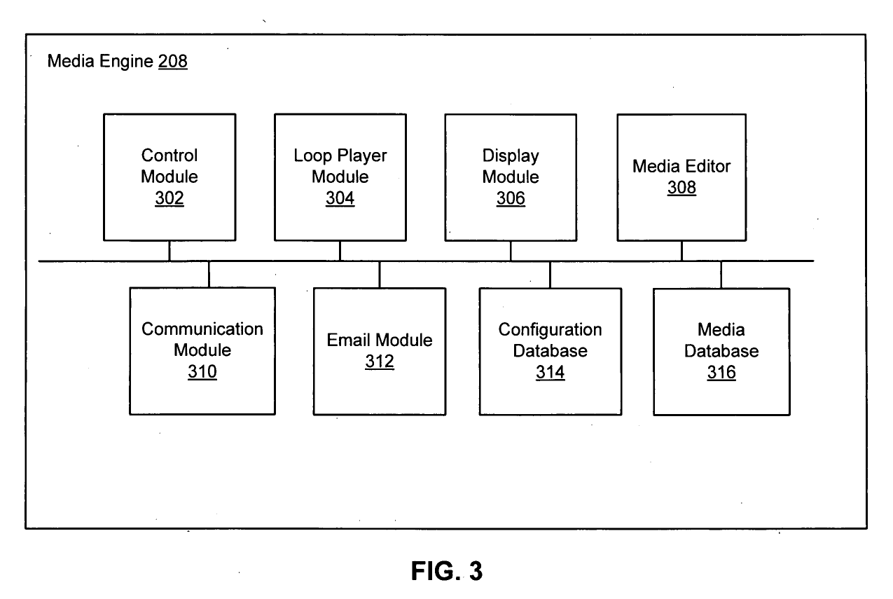

Referring now to FIG. 3, a block diagram of an exemplary media engine 208 is shown. A control module 302 manipulates the items of media 212 (FIG. 2) and constructs loops 210 (FIG. 2) having the items of media 212. The control module 302 can also specify a default speed at which the loops 210 play. Additionally, the control module 302 may coordinate the insertion of specified content from the content provider 216 (FIG. 2) into the loops 210 at specific times or intervals.

A loop player module 304 plays the loops 210 and receives user inputs to modify the display and contents of the loops 210. Thus, the loop player module 304 receives inputs from the user to create loops 210, modify items of media 212 or the loops 210, and/or remove items of media 212 from the loops 210. In exemplary embodiments, the user may choose from on-screen selections (e.g., buttons or drop down menus), manipulate on-screen items (e.g., dragging and dropping items of media 212), or issue voice commands to create or modify loops 210. In one example, the loop player module 304 may also be used to control a direction and speed the loop 210 plays. For example, when the user uses the player controls 110 (FIG. 1) to adjust the loop 210, the loop player module 304 receives the instructions from the player controls 110 and adjusts the loop 210 accordingly.

A display module 306 presents a graphical user interface (GUI) through which the loop player 102 (FIG. 1) may be displayed. Within the loop player 102, any number of loops 210 displaying items of media 212 may be viewed. The display module 306 also provides various modification interfaces on the loop player 102 through which users may modify the loops 210 or items of media 212. Such modification interfaces include, for example, drop down menus and player controls 110 (FIG. 1).

A media editor 308 allows the user to make adjustments to items of media 212. Thus, the user can use the media editor 308 to resize, rotate, configure, or format the items of media 212. For example, the user may resize an image or change a font type associated with the item of media 212. Any type of editing to the item of media 212 may be accomplished using the media editor 308.

An exemplary communication module 310 allows the media engine 208 to utilize facilities of the client 202 (FIG. 2) for communicating with the server 204 (FIG. 2). The communications may include providing and receiving updates for the loops 210 running in the media engine 208, and to transfer any other data between the media engine 208 and the server 204.

An email module 312 may be provided as a communication interface for electronic mails. The email interface 312 is utilized to send loops 210, media 212, metadata, or identifiers associated with the loops 210 and media 212 directly to other users. In a further embodiment, the email module 312 may also send invitation to other users to access shared loops 210. In another embodiment, the email module 312 sends the media 212 to other loops 210 on other clients 214. In an example, the client 202 sends the media 212 and a loop identifier as an electronic mail to the server 204. The server 206 incorporates the media 212 within the loop 210 identified by the loop identifier.

The exemplary media engine 208 may comprise a configuration database 314. The configuration database 314 stores identifiers associated with the items of media 212 and loops 210. In further embodiments, the configuration database 314 stores any type of data related to the loops 210 (e.g., information regarding the client 202, type and quality of attached network, communication performance, registration information for the client 202, preferences of the user at the client 202, version numbers for the loops 210). In a further embodiment, the configuration database 314 may be located outside of the media engine 208, and is accessible via a configuration database interface in the media engine 208.

The exemplary media engine 208 may also comprise a media database 316. The media database 316 stores the items of media 212 used in the loops 210. Any process for storing and/or locating the items of media 212 may be utilized in association with the media database 316. For example, a hash function may be utilized to index and retrieve the items of media 212 from the media database. In a further embodiment, the media database 316 may be located outside of the media engine 208, and is accessible via a media database interface in the media engine 208.

The exemplary media engine 208 shown in FIG. 3 is described as including various components. Alternative embodiments may comprise more or fewer components that those shown and still fall within the scope of embodiments of the present invention.

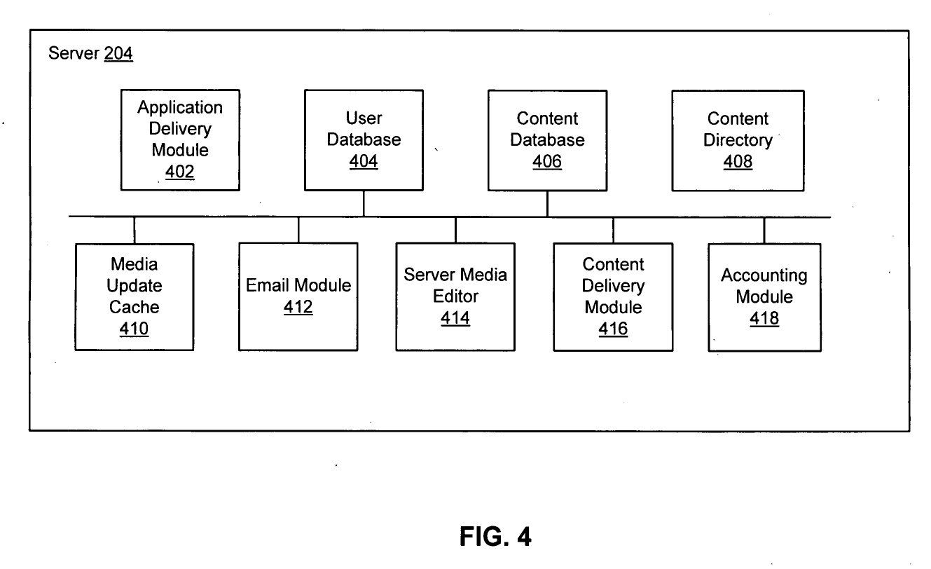

FIG. 4 shows an exemplary embodiment of the server 204 comprising various components associated with providing loops 210 (FIG. 2). An application delivery module 402 is provided for delivering the loops 210, the items of media 212 (FIG. 2) that comprise the loop 210, and updates (e.g., modifications) to the loops 210 to the appropriate client (e.g., clients 202 and 214). In an embodiment where the server 204 creates the loops 210 or maintains a master copy, the server 204 can send the loops 210 to the media engine 104 (FIG. 1) via the network 206 (FIG. 2). The application delivery module 402 may also deliver identifiers assigned to the loops 210 and the items of media 212 to clients 202 and 214.

The exemplary server 204 also comprises various databases including a user database 404. The user database 404 stores user information, such as name, email addresses, user identifiers, and any other data relevant for the user. The user database 404 may also store information associated with loops 210 created by the user or received from other users, and items of media 212 provided by the user. The user may be required to register certain information with the server 204 before the server 204 will provide loops 210 with items of media 212 to loop players 102 (FIG. 1) associated with the user.

Another database of the server 204 is a content database 406 which may store items of media 212, loops 210, and metadata or configuration information associated with the items of media 212 and the loops 210. As discussed herein, the items of media 212 and the loops 210 may include, for example, photographs, music, graphics, streaming media, animation, movies, graphics, and any other type of visual or audio data. The content database 406 may also store the keywords, titles, and comments of both media 212 and loops 210.

A content directory 408 may be provided for indexing the contents, keywords, titles, and comments stored in the content database 406. For example, a loop 210 associated with the word “surfing” (e.g., in the title) may be retrieved from the content database 406 via a search of the index in the content directory 408. Any indexing and searching mechanism is within the scope of various embodiments of the present invention. In a further embodiment, the content directory 408 may be included in the content database 406.

A media update cache 410 stores the items of media 212 that are utilized to update or modify existing loops 210. According to one embodiment, the media update cache 410 will store the items of media 212 that are currently being used to modify the loops 210. In an alternative embodiment, the media update cache 410 will store some or all items of media 212 used to modify the loops 210.

An email module 412 may send electronic mails for the user at the client 202 to one or more further clients 214 (FIG. 2), and vice-versa. These emails will provide the receiving client with information for retrieving the media engine 204 or the loops 210, and for constructing the loops 210. Alternatively, the email module 412 may receive electronic mails from the users at the clients 202 and 214. The electronic mails may comprise server 204 commands or requests to add attached media 212 to identified loops 210.

A server media editor 414 allows for modification of the items of media 212 similar to that of the media editor 308 (FIG. 3) on the media engine 204. In this situation, however, the user modifies the items of media 212 using the server media editor 414 via the server 204 instead of, or in addition to, the media editor 308. For example, the server media editor 414 may be used to resize photos, remove red eye, correct color balance, and so forth.

An exemplary content delivery module 416 provides content to be included as one or more items of media 212 in the loop 210. In one embodiment, the content delivery module 416 accesses content stored on, or associated with, the server 204 for the content. In an alternative embodiment, the content may be provided from the content provider 216 (FIG. 2). In this alternative embodiment, the content delivery module 416 may not be utilized.

In one embodiment, the advertising or content from the content delivery module 416 (or content provider 216) is provided based on an analysis of the user of the loop 210 or the loop 210, itself. For example, an advertisement for a family vacation to Disneyland® may be included in a family related loop 210. Any manner of determining advertisement or content to be provided, however, may be employed.

The server 204 may also include an accounting module 418. The accounting module 418 may track the items of media 212 in the loops 210 and the frequency and type of interaction each of the users has with the loops 210. Specifically, the accounting module 418 can track interaction between the user and the advertisement content included in the loop 210. Accordingly, the accounting module 418 can track monies owed to or from a provider of the advertisement content based on the user interactions. In some embodiments, the accounting module may comprise an accounting database that contains data regarding advertisement or commercial loops 210.

Although the server 204 has been described as including various components, more or fewer components may comprise the server 204 in accordance with alternative embodiments. For example, the server 204 may further include a search engine component or a communication interface.

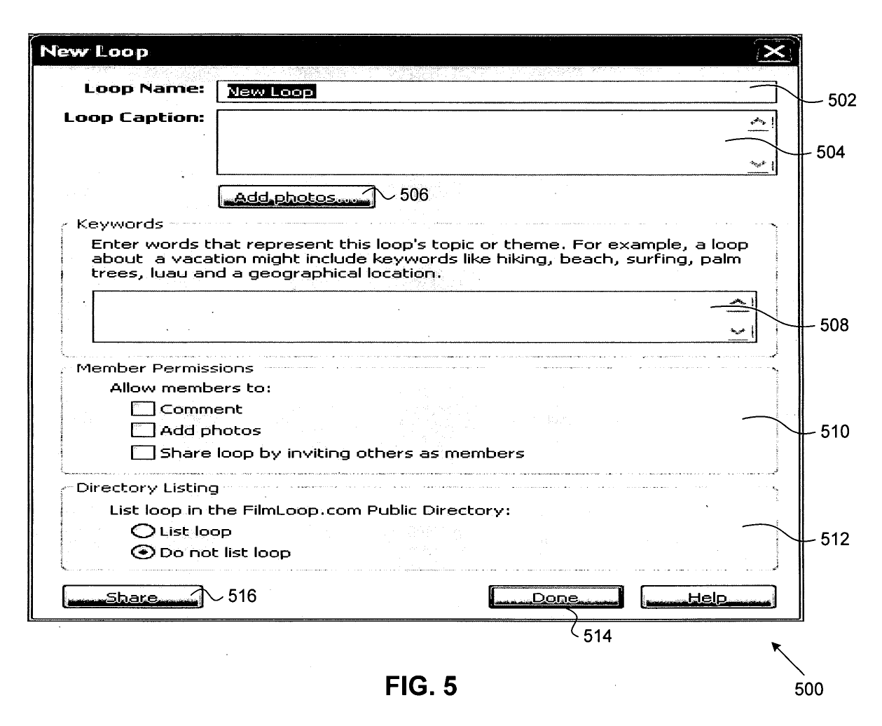

Referring now to FIG. 5, an exemplary new loop screen 500 for generating a new loop 210 is shown. The new loop screen 500 allows the user to enter data associated with creating the new loop 210 (FIG. 2). A user may create a new loop 210 by selecting a “new loop” option on the loop player 102 (FIG. 1). The “new loop” option may include a button on the loop player 102, a drop down menu on the loop player 102, or any other mechanism to initiate the creation of the new loop 210.

A loop name entry 502 is provided for entering a name for the new loop 210. The user may enter a title, subject matter for the loop 210, or any other naming mechanism. For example, the user may enter “Disneyland® Trip 2005” to entitle a loop 210 containing family photos from a trip to Disneyland®. According to one embodiment, the loop name entry 502 comprises a title box.

A loop caption entry 504 provides an area for entering data related to the new loop 210 which the user wants displayed in a caption of the new loop 210. For example, the user may enter text describing an event associated with the new loop 210 (e.g., “Susie with Mickey Mouse.”). In one embodiment, the loop caption entry 504 comprises a caption box for providing the caption(s).

An add photos option 506 allows a user to select photos or other items of media 212 (FIG. 2) from a directory, a website, or any other source to the new loop 210.

A keywords entry 508 is provided for allowing a user to enter keywords associated with the new loop 210. The same information entered into the loop name entry 502 and/or the loop caption entry 504 may also be included in the keywords entry 508, according to one embodiment. The keywords may later be utilized to search for the loops 210. According to one embodiment, the keywords entry 508 comprises a keyword box for entering the keywords.

A permissions section 510 allows the user to set permissions related to the new loop 210. The permissions indicate what modifications another member (i.e., a further user who shares the loop 210 created by the first user) is allowed to perform to the new loop 210. In the present embodiment, the user can allow the member to add comments to the new loop 210, to add photos to the new loop 210, and/or to further share the loop 210 by inviting more members. In further embodiments, the permissions section 510 may also allow the user to set permissions as to who is allowed to access the new loop 210 and/or what types of modifications other members may make to the new loop 210. Examples of various types of modification which may be allowed to be made by other members will be discussed in further detail in connection with FIG. 9. In yet further embodiments, the user may set different permissions for each member. For example, member1 can only access the loop 210, member2 can access and make any modifications the loop 210, and member3 can access and only add new items of media 212.

According to the present embodiment, the user sets the permissions by selecting boxes next to the permissions. Alternative embodiments may provide other mechanisms for setting permissions such as entry fields or a combination of boxes and entry fields. For example, the user may check a box to selectively allow access to the loop and then provide a list of members who are allowed access in an associated entry field or box.

A directory listing section 512 allows the user to include the new loop 210 in a public directory of loops. By allowing the new loop 210 to be listed in the public directory, users at any client 202 can access the new loop 210 via the public directory. The loops 210 in the public directory may be indexed and searched (e.g., using the keywords, titles, and/or captions associated with the loops 210). The public directory may be coupled to, associated with, or stored on the server 204 according to exemplary embodiments. While making the loop 210 publicly available, the user may still enact various permissions and restrictions on modifications to the loop 210.

Once the user is finished selecting and entering information into the new loop screen 500, the user can select the “done” button 514. A loop 210 will then be created having all the characteristics and permissions set in the new loop screen 500. If photos or other items of media 212 are added via the “add photos” button 506, the loop 210 will comprise those items of media 212. If no items of media 212 were added via the “add photos” button 506, a empty loop is created. The user may then add items of media 212, as described above, to the empty loop 210.

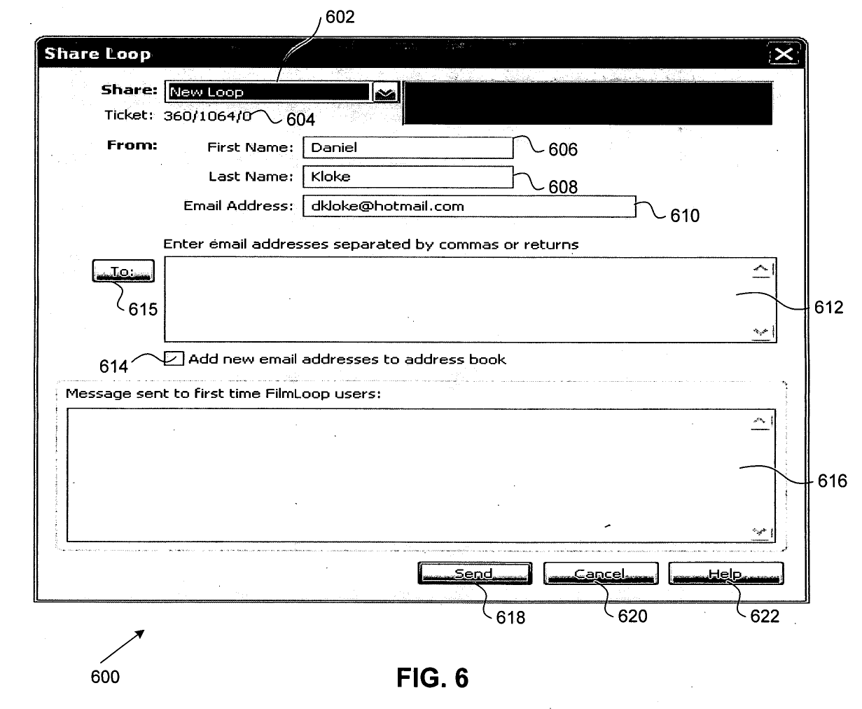

The user may also select a “share” button 516 in order to immediately share the loop 210. By selecting the “share” button 516, a share loop screen 600, as shown in FIG. 6, is presented to the user. In further embodiments, the share loop screen 600 may be presented by activating via a menu, or from any other icon displayed in association with the loop 210 or the loop player 102 (FIG. 1).

A drop down share menu 602 allows the user to select the loop 210 the user wants to share. Thus, the drop down share menu 602 will provide a list of loops (e.g., loops created by the current user) that may be shared. In an alternative embodiment, the selection of the loop(s) for sharing may be accomplished by other mechanisms. For example, a share loop entry box may be provided where the user may type in a name of the loop 210. In yet a further embodiment, the share loop entry box can be used to search for the loop 210 and provide the user with a list to select from. Thus, for example, the user enters keywords in the share loop entry box, and the media engine 208 searches for loops 210 having those keywords. Any number of loops 210 may be shared via the share loop screen 600.

A ticket identifier 604 displays an identifier that may be forwarded to a further user. The further user may use this ticket identifier to access or receive the shared loop(s) 210. In exemplary embodiments, the ticket identifier may be assigned by the media engine 208 or by the server 204. In further embodiments, the ticket identifier may be the identifier assigned to the loop 210.

A first name entry 606, a last name entry 608, and an email address entry 610 are provided for the user to list their contact information. In one embodiment, some or all of the entries 606, 608, and 610 may be automatically filled in by the media engine 204. Although text entry boxes are exemplified in the share loop screen 600, other mechanisms may be provided for providing the sharing user's contact information. For example, a drop down menu may provide a list of names and email addresses associated with the client on which the share loop screen 600 is currently being display.

An email entry 612 is provided for entering email addresses of one or more further users with whom the current user wants to share the loop(s) 210. The current user may also add new email addresses to an address book by selecting the add box 614. By adding email addresses to the address book, the media engine 208 may provide suggested email addresses of further users from the address book. For example, the media engine 208 may automatically fill in a remainder of an email address based on a first few letters of the e-mail address. Alternatively, the media engine 208 may provide a list of addresses when the user selects the “to” button 615. A message entry 616 may also be provided for entering a message to be forwarded to the further user(s).

The share loop screen 600 may include various other buttons such as a “send” button 618, a “cancel” button 620, and a “help button” 622. By selecting the “send” button 618 an invitation (e.g., email) is sent to the further user(s).

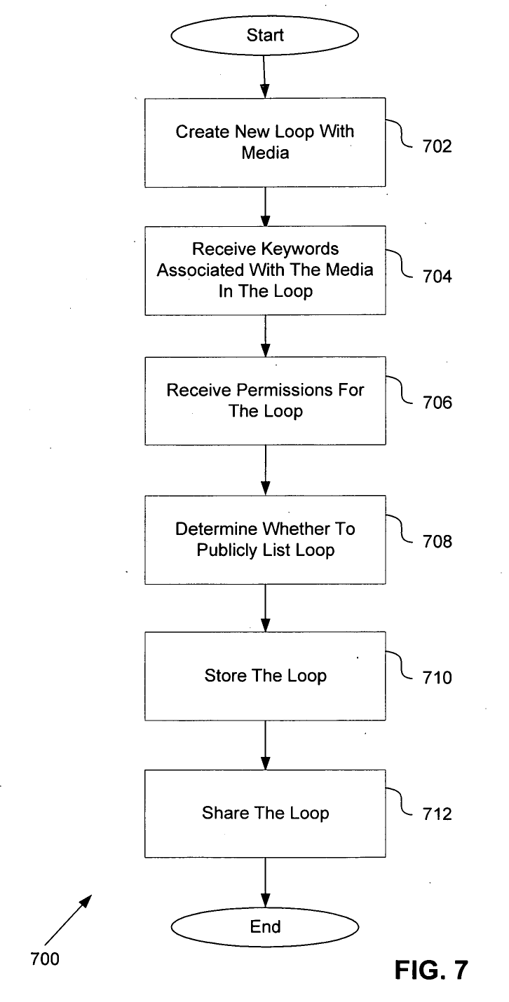

Referring now to FIG. 7, is an exemplary flowchart 700 of a method for creating and sharing a loop is shown. In step 702, the media engine 208 (FIG. 2) (or the server 204 of FIG. 2) creates a new loop 210 (FIG. 2) having items of media 212 (FIG. 2). The media engine 208 creates the new loop 210 based on inputs received from a user. When creating the new loop 210, one or more items of media 212 are added by the user into an empty new loop 210. Additionally, the user may enter a title for the new loop 210.

Keywords associated with the items of media 212 in the loop 210 are received by the media engine 208 in optional step 704. In exemplary embodiments, the keywords are entered via a keywords entry 508 (FIG. 5) on the new loop screen 500 (FIG. 5). The keywords may represent, for example, a topic, theme, events, or locations of the item of media 212 or the loop 210.

In step 706, the media engine 208 receives permissions associated with the new loop 210. The permissions may be received via a new loop screen similar to the new loop screen 500 of FIG. 5. The permissions may include permissions for accessing the new loop 210 and for making modifications to the new loop 210. Other permissions may also be provided as will be discussed in connection with FIG. 9.

The media engine 208 then receives instructions as to whether to publicly list the new loop 210 in step 708. Publicly listing the new loop 210 will include the loop in a public directory that may be accessed by the general public.

In step 710, the media engine 208 stores the new loop 210. In some embodiments, the loop 210 may be stored locally in a storage device associated with the client 102 (FIG. 1) being used by the user to create the loop 210. In other embodiments, the loop 210 is stored on a storage device associated with the server 204 (FIG. 2). In yet further embodiments, the loop 210 may be stored both locally and on the server 204. Additionally, a master copy of the loop 210 may be maintained on either the local storage device or on the server 204.

Once created, the loop 210 can be shared in step 712. In one embodiment, the sharing may occur via the public directory as discussed in step 708. Alternatively, the user may access a share loop screen 600 (FIG. 6) and send an invitation to at least one other user for accessing the loop 210. In further embodiments, the user may send (e.g., email) a copy of the loop 210 to at least one other user. Other methods of sharing loops 210 are contemplated by embodiments of the present invention.

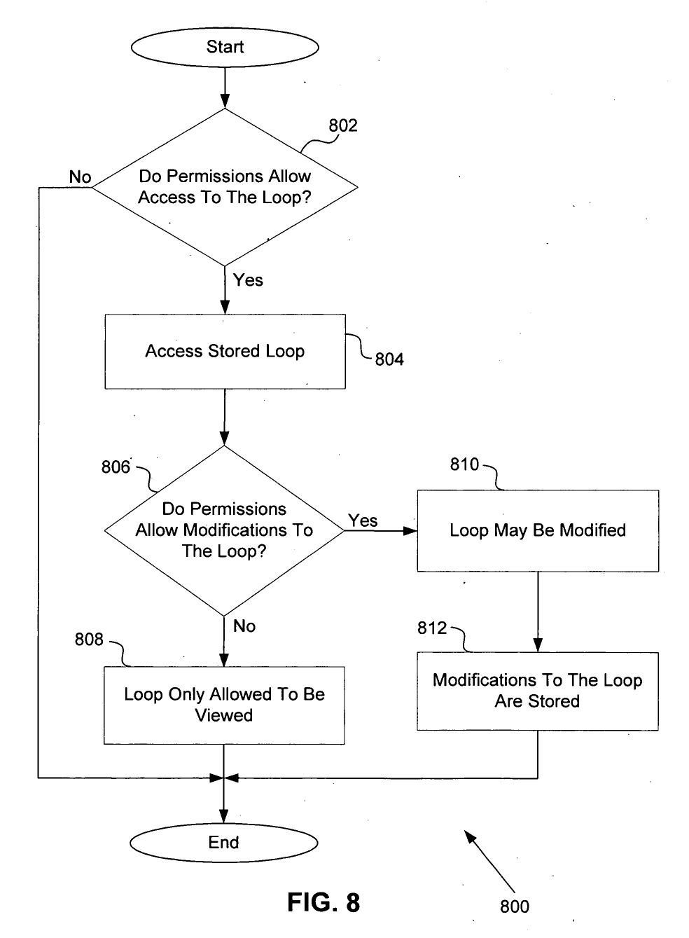

An exemplary flowchart 800 of a method for accessing and editing a loop 210 is shown in FIG. 8. A further user may attempt to access a shared loop 210. The further user may search (e.g., using keywords) a public directory for the loop 210. Alternatively, the further user may receive an invitation having a ticket identifier for the loop 210. In this case, the further user provides the ticket identifier to the media engine 208 (FIG. 2) or the server 204 (FIG. 2) in order to retrieve the loop 210 and its contents. In another embodiment, the user provides an item of media containing a ticket identifier to the media engine 208 or the server 204 in order to retrieve the loop 210 and its contents; for example, the user may provide an image file that contains the ticket identifier to the media engine 208, which then locates the ticket identifier in the image file, then retrieves the loop 210 (and its contents) that is associated with the ticket identifier. Any means of providing the media engine 208 with a ticket identifier is within the scope of this invention.

In step 802, the server 204 or the media engine 208 associated with the further user determines if the permissions of the loop 210 the further user is attempting to access allows the further user to access the loop 210. As previously discussed, a creating user may set permissions for the loop 210 that limit access to the loop 210 by further users. If permissions do not allow access by the further user, the further user is denied access. If the further user has permission to access the loop, the loop 210 is presented to the user in step 804. Thus, the loop 210 may appear in a loop player 102 (FIG. 1) associated with the further user.

Should the further user attempt to modify the loop 210 (i.e., modifications to the loop 210, the items of media within the loop 210, or metadata associated with either), the media engine 208 or the server 204 determines if the further user has permission to modify the loop 210 in step 806. As previously discussed, the creating user may set permission for allowing modifications to the loop 210. If the further user does not have permission to modify the loop 210, the further user is only allowed to view the loop 210 in step 808. Alternatively, if the further user does have permission to modify the loop 210, then the loops 210 may be modified in step 810 by the further user.

The modifications to the loops 210 are then stored in step 812. The modified loops may be stored as versions of the original loop 210 or as new loops. The modified loops may be stored on a storage device associated with the client 114 (FIG. 1) of the further user or the server 204. In further embodiments, the modifications to the loop 210 may be sent back to the creating user.

Referring now to FIG. 9, the step of determining if the further user has permission to modify the loop 210 (step 806 of FIG. 8) is described in more detail. In exemplary embodiments, the media engine 208 (FIG. 2) or the server 204 (FIG. 2) compares an attempted modification by the further user against the permissions associated with the loop 210. Thus, if the further user attempts to add a new item of media 212 (FIG. 2) to the loop 210, the media engine 208 or the server 204 determines if the permissions of the loop 210 allow the further user to added the new item of media in step 902.

Similarly, if the further user attempts to alter an existing item of media 212 (e.g., resize an image, change font size, red eye reduction, etc.), in step 904, the media engine 208 or the server 204 determines if the permissions allow altering an existing item of media 212 by the further user.

In step 906, the media engine 208 or the server 204 determines if the further user may rearrange an order of the items of media 212 in the loop 210. For example, the further user may want to move the third item of media 212 to after the fifth item of media 212.

The media engine 208 or the server 204 may also determine if existing items of media 212 may be deleted in step 908. Thus, when the further user attempts to drag an existing item of media 212 out of the loop 210, for example, the delete permission for the loop 210 is reviewed.

The media engine 208 or the server 204 also determines if comments may be added by the further user in step 910. The further user may comment on the loop 210 or on each item of media 212 within the loop 210. The comments are added by selecting (e.g., right click and select “comment” option) the loop 210 or the item of media 212 to be commented on, which will bring up a comment window. The further user may then add comments via the comment window.

Step 912 determines if a media link in the loop 210 may be altered. Media links can be associated with each item of media 212 in the loop 210. A media link determines what action will occur when the item of media 212 associated with the media link is selected by the user; for example, launching an internet web browser to a particular web page, retrieving another loop or more items of media. Thus, for example, accessing the media link (e.g., clicking on the item of media 212 associated with the media link) may bring up a related advertisement video or a second loop having more items of media related to the linking item of media 212. The media link may be embedded by the user upon creation of the loop 210 or at any time thereafter. The media link may also be added by subsequent users if allowed by the permissions set by the loop's 210 creating user.

The media engine 208 or the server 204 may also determine, in step 914, if the loop 210 may be shared by the further user with additional users. While the creating user may want to share the loop with the further user, the creating user may not want the further user to share the loop with any one else. Accordingly, this further sharing permission will be set negatively for the loop 210.

The above-described functions can be comprised of instructions that are stored on a storage medium. The instructions can be retrieved and executed by a processor. Some examples of instructions are software, program code, and firmware. Some examples of storage medium are memory devices, tape, disks, integrated circuits, and servers. The instructions are operational when executed by the processor to direct the processor to operate in accord with the invention. Those skilled in the art are familiar with instructions, processor(s), and storage medium.

The invention has been described with reference to exemplary embodiments. It will be apparent to those skilled in the art that various modifications may be made and other embodiments can be used without departing from the broader scope of the invention. Therefore, these and other variations upon the exemplary embodiments are covered by the present invention.

What is claimed is:

1. A method for creating a sharable loop, comprising:
incorporating at least one item of media into a loop;
receiving permissions for access and modification rights to the loop from a creating user;
storing the loop; and
allowing the loop to be shared in accordance with the access and modification rights.

2. The method of claim 1 wherein the access and modification rights comprise allowing new items of media to be added to the loop.

3. The method of claim 1 wherein the access and modification rights comprise allowing alterations to the at least one item of media in the loop.

4. The method of claim 1 wherein the access and modification rights comprise allowing an order of the at least one item of media in the loop to be rearranged.

5. The method of claim 1 wherein the access and modification rights comprise allowing deletion of at least one item of media in the loop.

6. The method of claim 1 wherein the access and modification rights comprise allowing the replacement of the at least one item of media in the loop.

7. The method of claim 1 wherein the access and modification rights comprise allowing comments to be added to the loop.

8. The method of claim 1 wherein the access and modification rights comprise alterations to a media link in the loop.

9. The method of claim 1 wherein the access and modification rights comprise allowing the loop to be shared with further clients.

10. The method of claim 1 further comprising assigning an identifier to the loop.

11. The method of claim 1 wherein allowing the loop to be shared comprises listing the loop in a public directory.

12. The method of claim 1 wherein allowing the loop to be shared comprises sending an invitation having a ticket identifier to at least one other client.

13. The method of claim 1 wherein allowing the loop to be shared comprises providing a hypertext link containing a ticket identifier on an internet web page.

14. The method of claim 1 wherein allowing the loop to be shared comprises providing an image file that contains a ticket identifier.

15. The method of claim 1 wherein allowing the loop to be shared comprises providing an audio file that contains a ticket identifier.

16. The method of claim 1 wherein allowing the loop to be shared comprises providing a video file that contains a ticket identifier.

17. A method for allowing access and modification to a loop, comprising:
receiving a request from a client for access to the loop;
determining if the client has permission to access the loop; and
providing access to the loop if the client has access permission.

18. The method of claim 17 further comprising determining if the client has permission to modify the loop, and allowing the client to modify the loop if the client has modification permission.

19. The method of claim 18 wherein determining if the client has modification permission comprises checking a permission set associated with the loop.

20. The method of claim 18 further comprising storing the modifications to the loop.

21. The method of claim 17 wherein the request for access to the loop comprises a ticket identifier.

22. The method of claim 17 wherein determining if the client has access permission to the loop comprises checking a permission set associated with the loop.

23. A computer readable medium having embodied thereon a program, the program providing a method for creating a sharable loop, the method comprising:
incorporating at least one item of media into a loop;
receiving permissions for access and modification rights to the loop from a creating client;
storing the loop; and
allowing the loop to be shared in accordance with the access and modification rights.

24. A computer readable medium having embodied thereon a program, the program providing a method for allowing access and modification to a loop, the method comprising:
receiving a request from a client for access to the loop;
determining if the client has permission to access the loop; and
providing access to the loop if the client has access permission.

25. The computer readable medium of claim 24, wherein the method further comprises determining if the client has permission to modify the loop, and allowing the client to modify the loop if the client has modification permission.
